(19) United States
(12) Patent Application Publication
(10) Pub. No.: US 2002/0025437 A1
(43) Pub. Date: Feb. 28, 2002

(54) Coating and construction material and applications thererof

(76) Inventor: Frede Sorensen, Langa (DK)

Correspondence Address: NIXON PEABODY, LLP, 8180 GREENSBORO DRIVE, SUITE 800, MCLEAN, VA, 22102, US

(21) Appl. No.: 09/904,562

(22) Filed: Jul. 16, 2001

Related U.S. Application Data
(63) Continuation-in-part of application No. 09/147,167, filed on Oct. 21, 1998.

(30) Foreign Application Priority Data
Apr. 25, 1996 (DK) 0498/96
Feb. 21, 1997 (DK) 0193/97

(51) Int. Cl. B32B 5/16

(52) U.S. Cl. 428/407; 428/484; 428/522

(57) ABSTRACT

A construction, molding or coating or impregnating material that is formed a wax material that includes an EVA polymer or copolymer additive in an amount of 20-50 weight %. The material has a penetration value according to ATSM standard D-1321 of 0.5-6 and a melting point in range of 102-125° C.

### RELATED APPLICATIONS

This application is a continuation-in-part of U.S. patent application No. 09/147,167, filed Oct. 21, 1998, the disclosure of which is incorporated herein by reference.

### BACKGROUND OF THE INVENTION

1. Field of the Invention

The present invention relates to a new type of material and different applications thereof, viz. a wax material with particular qualities.

2. Description of Related Art

An example of a modified wax is found in U.S. Pat. No. 4,239,546 to Russel et al. wherein all suitable types of waxes are modified with suitable polymers, in particular hydrocarbon polymers. Hereby is obtained a material with increased hardness as compared to materials making up the modified wax.

Hardness is expressed as a penetration value according to ASTM standard D 1321 which is a recognized standard in the petroleum wax industry.

An example of applying wax to an article's surface can be found in U.S. Pat. No. 4,263,338 Rentemeester et al. By this method the wax is preheated to a relatively high temperature under pressure in order to obtain a low viscosity whereby the wax can be applied by a spray gun to the object. The method thus requires the wax material to be preheated under pressure in order to obtain a free flowing hot liquid which is can be sprayed. The method is specifically developed in order to apply release agents onto packing materials in the meat business.

Wax is known as a pure natural product, e.g., as bee's wax, but for technical applications in larger amounts, it is necessary to rely on artificially produced wax, which is derived from mineral oil, yet still being a natural product, best known as paraffin wax. It is widely used for candies which consist of fully refined paraffin wax with a melting point in the range of 48-62° C. This wax is relatively soft; its hardness is typically expressed by the term ‘penetration’, which refers to the intrusion depth of a measuring needle into the material, in the present connection according to ASTM standard D 1321, the penetration figure of the paraffin wax ranging from 30 to 60, higher the softer the material is. The wax is water-repellent and chemical resistant as well as totally degradable in the nature, and it is used also for various impregnations, e.g., of paper and ropes, the wax also having a certain lubricating effect. However, due to its softness and low melting point, the wax has only limited possibilities for technical applications.

It has been found, however, that in mixing the wax with various polymers and other substances it is possible to increase the hardness and the melting point of the wax to such a degree that this modified wax, would be useable for further applications, viz. mostly as so-called hot melt coating on foodstuff cartons, as a coating for avoiding intrusion of oxygen from the outside and extrusion of moisture from the inside, the product still being fully environment friendly. With the increased wax melting point, for example, a foodstuff carton may be left temporarily in sunshine without the wax coating flowing out in the carton. Correspondingly, the wax exhibits an increased hardness, now typically with a very low penetration value of only 8-15, whereby it is less supple, yet still readily flexible. In connection with porous surfaces it is still usable for impregnation, but apart from the said carton coatings, the modified wax has not found extensive use on other technical areas.

### SUMMARY OF THE INVENTION

In connection with the present invention it has been found that it is possible to modify wax material still further, viz. for attainment of a further increased hardness in the penetration range of 0.5-6 which, in connection with a correspondingly increased melting point, opens a long row of further possibilities for use, as the material now appears as ‘hard’ and wear resistant at ambient and even higher temperatures. The material, then, is also more brittle, but this can be highly advantageous, as will become apparent from the following more detailed description of the modified material, now designated ‘hard wax’.

At normal temperatures, this hard wax does not exhibit any conventional wax character, as it occurs as a neutral, hard solid, which is cheap, environment friendly, corrosion resistant and workable, while also having good resistance to wear. In particular, due to its ability to be cast out as a low viscosity liquid in a temperature range of from above 100° C. to 200° C., it is well suited to form castings without heavy requirements for the form equipment and with the possibility of a high degree of detailing. The possibilities for use are so numerous that they will not be further listed here. It should be mentioned that the material, when cast as a thin shell, is or can be toughly resiliently bendable. By way of example, the mouth of a cast drinking cup with a wall thickness of approximately 1 mm may be pressed together without the material breaking, while the mouthing willingly returns to its original shape. The wax may be colored as desired and may also be cast into plates or blocks, optionally for further working. All waste material from the working will be fully reusable. The working may be effected in conventional manner, but also with the use of heat, e.g. from a glowing wire. For the material, it is in fact more relevant to speak of its hardness (Shore) rather than its softness (penetration).

In connection with the invention it has been found, surprisingly, that there are very good reasons for increasing the degree of modification of the wax noticeably further than to the prior art level. Apparently, there are no special or principal difficulties in doing so, as the desired result can achieved already by an increased admixing of the substances, primarily polymers, which are used already for the production of the semi hard wax. In the relevant technical area, the experts possess great knowledge as to the effect of the different additives, e.g., for adapting the wax to different purposes of use, and of course it cannot be excluded that for the formation of the hard wax there exist or can be developed particularly well suited additives, such that also the hard wax can be modified for different applications. For the present invention additives selected among primarily polymers, and in particular ethylvinylacetates or other related biodegradable polymers are preferred.

For the invention, it has been essential to make sure that it is in fact possible to produce the hard wax, based on known principles, such that it will still be 100% environment friendly.

An essential application is as the so-called hot melt coating, i.e. as a protective and partly impregnating coating on surfaces of many different types. In fact, it has been a starting point for the invention to provide a surface protection of concrete surfaces, because at many places there are problems with respect to corrosion of concrete surfaces, in particular by the action of acid media such as acid rain and acid moisture in sewer pipes. It is known that these surfaces may to some degree be protected by application of certain coating materials, but it seems true that the more efficient of these materials during application, use and removal are definitely not environment friendly and, besides, are relatively expensive.

The hard wax according to the invention is extremely well suited for this application, insofar as, with suitable heating, it is easy to apply onto the concrete surface, where it will easily intrude into the pores and micro cracks thereof, whereafter, in cooled condition, it will occur as an almost stone hard and wear resistant coating, which is totally water-repellent and therewith corrosion protective because of its own resistance to chemicals.

Further experiments with the invention have shown that the hard wax also is well suited as a wear resistant and anti-corrosive coating on metal surfaces, for example on cast iron, but also on iron and steel surfaces generally. As the wax may be dyed as desired, it will thus be possible in one operation to carry out both a corrosion protective priming and a final painting of the surface. However, it will still be possible to finally treat the hard wax layer with a paint coating, e.g. of the type “metallic” as known from the car industry.

Correspondingly, the hard wax may be used as a wear and weather resistant coating on wooden surfaces, e.g. on outer doors, it will apply generally that local damages such a scratches can be mended just by a heating of the wax layer in the relevant area, e.g. by means of a hot air blower or a blowtorch, whereby the material will flow together in a smooth manner in the scratch area.

For the application of the wax, the surface to be treated has to be free of moisture, as otherwise a boiling would occur that would jeopardize a good bonding of the wax, in practice this implies that any surface to be treated should be exposed to heating to such an extent that all moisture has boiled away or evaporated prior to the application. Such a heating, e.g. with a hot air blower or a blowtorch, should even be effected to the extent that the surface temperature approaches the melting temperature of the wax for ensuring that the low viscid wax can intrude into the pores present in surfaces of almost any type, including smooth metal surfaces. At the same time it will be ensured that the surface is degreased before the application.

For the coating of articles which already have the required high temperature, e.g., still hot metal castings, the wax may be applied in a pulverized, cold condition, optionally even as an aqueous wax emulsion. It is a further possibility to coat a cold or semi warm article with wax powder or granules, with or without filler material and heated to the sticking point, whereafter the wax layer is brought to flow together by heating as with known powder lacquering.

For the surface coating purpose, the wax can advantageously be mixed with graphite or iron oxides and, optionally, earth colors or fat colors, whereby it is possible to achieve a particularly good durability and a stable coloring.

A further field of application of the hard wax according to the invention is the use as a bonding agent f or admixed reinforcement or filler materials.

Thus, the hard wax will be an environmentally very advantageous substance in connection with all possible mineral fiber products, in which typically polyester has been used for the bonding of the strength giving filaments, particularly in glass fiber materials. The hard wax is a very effective adhesive which, at least in many connections, may replace the polyester, whereby already in the production phase the environmental qualities of the material prove advantageous in that there will be no special requirements to ventilation or breath protection.

It is equally important that the hard wax is well applicable as a molding or coating material in admixture with granular fillers such as sand, as this may obviously contribute to low production costs and extra hardness and wear resistance where this is desired. Also other characteristic properties such as lightness or cuttability can be aimed at, highly influenced by the applied additional materials.

As an example, reference is made to the metal casting technique and its associated use of casting molds and so-called casting cores, where in particular the latter are made of molding sand in admixture with directly dangerous bonding agents which, in the relevant forgeries, require excessive safety measures such as highly effective exhaustion systems. The individual molds or cores can be used once only, and owing to their contents of dangerous substances they should after each casting be conveyed to special deposition areas for dangerous waste, in quite large amounts.

The invention will provide for a marked shift in this picture, as it may be possible to produce the cores/molds of a sand material bonded solely by the use of an environmentally neutral wax material according to the invention. At the outset, such a material mixture will be willingly shapeable by a suitable semi high temperature in any model mold, whereafter it sets to a rigid state at room temperature.

When the same core or mold body is later on operatively exposed to the marked higher temperature of the molding metal, of course, the wax will be heated to above its melting point, but it is here decisive whether the surface contact can be established rapidly enough to condition that the molding metal reaches to solidify by its surface contact with the core/mold before the latter is thermally brought to an unstable state. It has been found that it is possible in many instances to use cores/molds made in accordance with the invention, and a very important result is that the same cores or molds, when used, can be melted for direct reuse, without in any way being transported to some deposition area and still without any kind of internal environmental problems.

It will be possible to prepare molding materials by coating the filler material, e.g., sand, with the hard wax, whereafter such a material may later on be filled into a desired mold and be heated for flowing together therein.

Correspondingly, such a material can be used for other molding purposes, for example, for a supportingly filling out of a cavity which is left in connection with the raising of a well frame body. The viscosity of the material can be varied all according to the heating temperature, but also for a coated loose material as well as for the pure wax in a granular state it will apply that the material will remain loose under all normal climatic conditions.

As a basis for further possibilities of application of the material according to the invention it should be mentioned that by a melting together of the wax coating of only semi large particles, e.g., larger grains of sand, it is possible to produce block or plate bodies of a porous type, which will allow for a through-flow of air, but resist an intrusion of water occurring with some surface tension. This will be useable for different purposes, e.g., for filter materials and for soil covering at places where plant growth is undesired.

The hard wax has a melting temperature considerably higher than that of conventional wax, e.g., over 100° C. versus 50° C. This is significant in connection with normal climatic impacts on the wax, insofar as a hard wax according to the invention will generally be fully resistant towards climatic influences, where conventional wax is not. An illustrative example is that the invention has been found interesting in connection with fire safety closing of garbage bins in special surroundings, where a carrier frame above the bin holds a pivot lid, which is held in its open position by way of wax adhesion, in case of fire, the wax will soon melt and free the lid to drop down, but the problem is that this may also happen by purely climatic influence on hot days or in direct sunlight. With the use of a modified wax with a melting temperature of e.g. 102-125° C., the fire release will take place practically as efficiently, while the troublesome incidental releases will be entirely avoided.

The relatively high melting temperature will also be of importance for the applicability of the modified wax as a binder in cast products in general, as these will then be fully climate resistant. The wax may be used for the bonding of all possible filler materials that can resist the temperature required for the casting process, e.g., about 150° C. With the use of a filler material of stone it is possible to produce a “wax concrete” that will he useable for many purposes, e.g., for the casting of floors or floor elements for animal stables, where the floor will then he resistant to the urine of the animals.

Hereafter, a special and likewise important aspect of the invention should be referred to, viz. the application of the hard wax for temporary surface coating of material particles, the substance of which should be delivered to the surroundings in a retarded manner. Presumably, a conventional wax material will be unsuitable for this purpose, because it will encapsulate the active material to the effect that the latter will be totally isolated from the surroundings until the wax layer itself is degraded, e.g., by the influence of earth bacteria. In connection with the invention, it has been found that in treating fertilizer granules with the hard and quite inexpensive wax material, i.e., in bringing the granules briefly in contact with the melted wax, the result is achieved that the fertilizer, upon being spread on the ground, delivers its active substances with a marked retarded or long term effect. The fertilizer is rendered immune towards rapid washing out in connection with rain showers, and it fully retains its active effect over a long time, this suggesting a solution of heavy economical and environmental problems in the agriculture.

The reason for this effect is that crack formations will occur in the hard and thin wax film around the particles, which enable a slow delivery of the active substances in aqueous solution, without heavy rain showers changing this picture noticeably.

Another important finding is that the earth bacteria over the time will effect a complete degrading of the non-toxic wax material whereby, over the years, there will be no accumulating build-up of foreign matter in the ground.

This is suggestive of a marked reduction of the use of fertilizers and a still more marked reduction or perhaps total elimination of the washing out thereof, as widely discussed in the present years.

In quite the same manner it will be advantageous to encapsulate granular weed killers for achieving both a long term effect thereof and a strongly reduced washing out in the ground.

For such wax coated materials used in warmer open air, it is advantageous—or rather simply a condition, that the wax should have a relatively high melting point, preferably above 70° C., such that a clogging or baking together cannot take place, e.g., in sacks exposed to sunlight. Another important advantage is that the hard wax is not adhering, as a granular material will thereby maintain its ‘free’ character for use e.g., in spreading machines.

Moreover, it will apply in general that the wax encapsulation will render the materials non-dusting where ever they are reloaded or brought out.

The coating of the granules may be effected by a brief bringing together of the granulated material and the melted wax, whereafter the material is subjected to a violent agitation in air, preferably in cold air, e.g., by whipping or in a rotary drum, until the thin wax films have cooled sufficiently to be non-adhering. It is supposed that the wax can be applied also by subjecting a falling flow of the granules to an injected flow of atomized low viscid wax. For certain applications it may be an acceptable or even preferred result that the granules may hereby not be entirely surrounded by the wax.

Another area, in which a correspondingly useful effect of a hard wax coating has been found, relates to the fighting of ice slippery roads by means of road salt. With the use of salt coated by a film of hard wax, a noticeable long term effect of the salt is achieved. Some wax remnants will remain on the road, as the degrading will take some time, but it is expected that these remnants will be collected in the small cavities of the road surface, whereby they will even protect the cavities against salt intrusion. The coated salt will be directly applicable on gangways, bicycle paths and parking places. Also other granular materials may be relevant, e.g., washing powders.

It should be noted that the wax material may qualify as a “food grade” material, i.e., as a totally non-dangerous substance, which may then also be applicable as a coating material on medical drystuff preparations for human or veterinarian use, for achieving a retarded medicine delivery by administration into the digestion system, or respectively, for retarding the degrading of e.g., fish fodder.

At the same background, the material will be applicable for all relevant kinds of packing materials for foodstuffs.

It should be mentioned that the material according to the invention, with suitable fillers, will be very well suited for sculptural purposes, both in connection with casting and working, partly because the products will be climate resistant and partly because in the working it is possible to add material by melting it against an existing surface portion.

The wax material itself is not heat conducting, and even though it can be mixed with particles, such as aluminum chips, that will increase the heat conductivity, it will be possible to take advantage, e.g., in the furniture industry, of the fact that a wax filled surface layer e.g., on a metallic support will act “warm” and very touch friendly, now without being in any way wax-sticky. This is believed to open up for new and advantageous construction possibilities in the furniture industry, while also giving rise to interesting aspects in many other technical fields.

Common to all applications will be that the final result is an advantageous product that will be totally degradable in the nature without the slightest damaging influence thereon, but yet highly resistant as long as it is kept free of the degrading earth bacteria and from higher temperatures. This widely corresponds to the conditions of use of another construction material used through thousands of years, for example wood, now only appearing also as a moldable and impregnating material.

It has been mentioned that the wax may be dyed by environmentally neutral earth and fat colors, of which the latter are available in all possible nuances. It is hereby an advantageous possibility to use the wax as a coating on sand or other granulates to be laid out in a colored condition e.g. on tennis courts or other places, where the color layer will be completely non-dangerous and where the hard wax will ensure that the area remains penetrable for water.

A highly efficient painting of articles can be obtained simply by dipping the articles in a bath of the melted wax, or the melted wax can be applied to fixed surfaces by some spraying or brushing technique.

According to the present invention it has been found that there is no need for developing special application techniques for the hot wax, as it has been realized that instead of departing from a “wax bath” made e.g. of melted pieces of wax, it is also possible to apply the “hard wax” in a granular condition thereof and make use of already well known methods and equipment for converting granules or powder of more conventional thermoplastic materials into “paint” or “a coating”. It is possible to dip an article into a powder or granular mass of the hard wax in order to obtain a sticky adhesion of the material to the article surface and then subject the thus coated article to a heating treatment in order to make the wax particle coating flow together in a continues paint layer. Such an adhesion could be provided for by making the wax particles slightly adhering by incorporating in the wax material a certain amount of an oily constituent. A similar result will be achieved by coating the article with some sticky substance prior to the article being dipped into the particulate wax material.

### DETAILED DESCRIPTION OF THE INVENTION

The wax according to the present invention has very low penetration values, i.e., in the range of 0.5-6 according to ASTM standard D-1321, whereas other modified waxes will have corresponding values above 8. This unique hardness is achieved by modifying the wax, preferably a paraffin wax with environmentally friendly additives, preferably EVA as well as other related biodegradable polymers.

The finished product is in granular form.

If the modified wax is to be applied by the electrostatic method, i.e., by charging the object to be coated as well as charge the modified wax, the wax is frozen to about −80 to −100° C. and thereafter ground to a powder with particle size of 100 to 400 μm. The object to coated is then suspended close to a cloud of charged wax particles whereby a uniform coating will be applied due to the opposite charging of particles and object.

Where the coating is to be applied in a spray process, the granules at room temperature are fed to a spray device comprising heating means, for example, in the nature of a blowtorch or an electrical heating element. As the granules pass the spray device, the wax particles/granules are heated so that when they reach the surface to be coated, they are sticky and the wax particles will flow together in order to form a continuous coating. The object to be coated can also be preheated, whereby an especially good coating is achieved.

Where the modified wax is used as a joint filler, for example, between cobble stones, tiles and the like, the wax in granular form is arranged in the joints. Usually, a sand filler or other suitable filler material has been coated with the wax prior to being filled in the joints. The granules with or without filler are non-sticky and can therefore be placed directly on the surface wherein the joints are wished to be filled. The granular material is then placed in the joints by brushing back and forth. When the joints are filled with granular material (wax coated sand) they are exposed to a short heat treatment whereby the granules melt together and thereby create joints which are water-resistant, homogenous, resistant to abrasion from sweeping and the like.

When coating particular materials, for example, sands as used in the example mentioned above, the coating may be applied by the whirl sintering method, wherein the filler, for example, sand, is heated. After heating, but while the filler is still hot, the filler particles are let through a fluidized whirling mass of wax particles. When the hot filler particles impact with the modified wax particles, the filler particles' heat will cause the wax particles to melt and adhere to the filler particles and thereby coat these.

One important aspect of the invention is wherein particles are coated as described above is for temporary coating of material. In some applications, it is desirable to have a temporary coating on the material whereby the effect of the coated material can be delayed. This is, for example, the case when taking about fertilizers. The material according to the invention is hard and thereby brittle. The coating of a fertilizer particle will therefore be thin and brittle which will cause it to crack once it is impacted either in the distributing machine or as it hits the ground. The fertilizer material will hereafter be slowly flushed out through the crack in the coating material. Furthermore, earth bacteria will degrade the coating material and slowly the fertilizer material will be distributed in the immediate environment. As the fertilizer is absorbed by the surrounding soil and the earth bacteria is eating away the wax material the effect of the fertilizer is prolonged and the fertilizer as a hole leaves no environmentally damaging traces behind. As a consequence of this, the use of fertilizer could be reduced as it will be possible to create a longer effect of the same amount of fertilizer as it will not be washed out of the soil due to rain falls and irrigation.

In the same manner, it will be advantageous to encapsulate granular wheat killers for achieving both a long term effect and a reduced amount of wheat killer being let into the environment.

These advantages are achieved by using the modified wax according to the invention as this wax is hard at normal temperature as well as having a high melting point. For modified waxes known from the art having melting points which are substantially lower and which are softer these advantageous effects will not be obtained as the lower melting point can cause the wax to melt due to exposure to sun shine. When the wax melts the cracks in the encapsulated particles will be sealed as the wax flows together due to the sun. Therefore, by using the inventive wax according to the invention a hole new application has become available.

### EXAMPLE

A wax useable for the applications mentioned above has the following important material data:

softening point: 102° C.-120° C., ASTM E 28

penetration: 1/10 mm 25° C., 2-6 ASTM standard D 1321

viscosity: mPA.S 130° C. 280-380 ASTM D 3236

color: L0.5 ASTM D 1500. The above mentioned material properties where achieved with a wax based on a paraffin wax modified by adding substantial amounts of a polymer, namely, an EVA (ethylvinylacetate).

In a preferred embodiment, the EVA copolymer content was approximately 25 weight % with a VA content of approximately 30 weight %. The resultant preferred material has a melting point in the range of 102° C. to 125° C.

It has also been briefly mentioned that the wax can be used in an aqueous emulsion for the coating of hot objects. It will be appreciated, however, that the material in an emulsified state will condition still further application possibilities.

In a further advantageous embodiment of the invention, it has been found that the material is suitable for mixing with mineral or vegetable oil, and that there is hereby also a basis for applications with considerable advantages.

In a further advantageous embodiment, the invention thus concerns an oil-based treating or impregnation agent, respectively items treated or impregnated with this agent, and depending on the purpose for which it is used, different mixture ratios can be involved for the said wax in the oil used, ranging from up to 5% wax in a free-flowing fluid e.g., for maintenance purposes, to up to 75% or more for paste-like masses.

This application is especially useful for the treatment and aftercare of floor covering elements and floor surfaces of wood, marble and linoleum. It is commonly known that, for the conservation and in order to ease the cleaning of said floor surfaces, it is advantageous to treat these surfaces with various oil products based on mineral or vegetable oil, with or without additives. It is also known, however, that oil-treated wood can “sweat” with oil as a result of exudation, which is not desirable under any circumstances.

Another known wood-treating agent is natural or synthetic wax, which is effective against drying-out of the surface, and it is already known to work with a wax-containing oil which has good penetration characteristics, and which in the surface itself forms a wax layer which has a restrictive influence on said exudation of oil. The resulting surface, however, will not be particularly attractive, the reason being that it will typically assume a, waxy character, i.e., it will appear ‘greasy’ and partly dirt absorbing, although also partly dirt rejecting.

It has been found that a distinct advantage can be achieved when an amount wax is in the base-oil, which wax is characterized by having a high softening temperature and a high degree of firmness and durability at normal temperatures of use. Surprisingly, it has proved that the special characteristics of the wax according to the present invention mixed with a mineral or vegetable oil with regard to firmness and wearing quality etc. will manifest themselves in a wood surface which has been impregnated by simple coating with or spraying on of a wax-enriched oil in the cold state, without the surface having to be heated.

Here, it shall be noted that the said special wax materials distinguish themselves by appearing with a relatively great hardness given at a low penetration factor of below 6, measured in accordance with the ASTM standard D 1321 standard, and a relatively high melting point, in the case of the present invention, most preferably in the range of 102° C.-125° C. The pronounced hardness involves that the surface of the material appears with a non-waxy character, i.e., without appearing greasy in any way, and to this can be added that the same surface is distinctly hard-wearing.

It shall be mentioned that a preferred wax for the purpose is a hydrocarbon wax modified with EVA (ethyl vinyl acetate) copolymer with a relatively high content of vinyl acetate (VA). Typical data can be a melting point of 125° C., a viscosity of 400 mPas at 130° C., and hardness (penetration) 2 cf. ASTM D 1321.

With admixture percentages of the wax in the oil of up to approx. 20%, e.g., paraffin oil, the mixture can be homogenized mechanically. An admixture of 5% gives an end product in the form of a milk-white fluid liquid with a viscosity of approx. 10 mPas at 50° C., a boiling point higher than 200° C. and a flame-point higher than 190° C. The product is stable under storage and does not display any sedimentation over longer periods. The product is superior to other products with regard to its barrier characteristics, appearance and wearing quality, and it is also totally neutral environmentally.

With a wax admixture of 15%, the product remains fluid with a viscosity of 35 mPas at 50° C., while an admixture of 30% results in a cream-like paste with a viscosity of 75 mPas at 50° C. This product is suitable for the surface treatment or impregnation of e.g. metal, leather and wood, with superior barrier effect and durability.

The treatment agent is produced simply by melting of the firm wax in hot oil, e.g., at 150° C., in that the wax, e.g., in granulated form is dosed until the desired concentration is achieved. Depending on the purpose for which it is to be used, different concentrations can be involved, e.g., beginning with 5% for free-flowing liquid for maintenance purposes. At higher concentrations, the wax content will function as a thickening agent, i.e., up towards a paste-like consistency at 75%.

Especially in the first-time treatment of coarser floor surfaces, use can be made of an oil with 10-20% wax, typically 15%. The liquid is sufficiently viscous to penetrate into the wood for the reinforcement of its structure from the inside. After such a “preliminary” impregnation, which can possibly be finalized with a heat treatment of the surface. e.g., merely by the frictional heat from a polishing machine, there can subsequently be effected an after-treatment with a 5% liquid which is applied from time to time in cold state and without subsequent heating.

The wood will hereby be effectively conserved for extension of the lifetime of the wood product. The surface of the wood will appear with a hard, durable and silk-mat finish which does not appear “greasy” in any way. No separating-out of the oil occurs, and the surface wax will have a preventive effect against exudation of the oil from the wood. The treatment will ensure a certain elasticity in the surface structure, which makes it robust and resistant to scratches and cracks. The surface is sealed against the ingress of water, but still allows the wood to breathe. The resistance to wear is considerably increased.

The widespread presence of the wax material in the surface itself renders it water-repellent and not easily susceptible to dirt retention. With cleaning trials which have been effected, it has been ascertained that the consumption of water necessary for an effective cleaning can be around eight times less than with a corresponding floor which has not been treated with the agent.

The admixture agent can be dyed, and it finds excellent application for purposes other than floors, namely for the protection of wood in the wider sense. With semi-porous surfaces—also of other materials—an overlapping area can arise with regard to the application of wax either by heat application of the wax as such or hot or cold application of the oil-based treating agent.

In principle there is nothing to prevent additional conservation agents being added to the treatment agent, but the agent will be a purely natural product particularly when use is made of vegetable oil, in that the wax involved is foodstuff-approved, and it is preferred to avoid any additive which is not completely nature friendly.

In the treatment of wood or other porous surfaces, the structural density of the material must be taken into account, in that the more open the structure, the greater must be the viscosity of the treatment agent. The oil is utilized as transport agent for the wax, which is filtered out gradually as the mixture penetrates forward to finer structural parts, which in part can be formed by the wax in itself. In this way, a good impregnation ingress of the oil is permitted, while at the same time the wax sets itself as an effective barrier in and directly under the surface. Depending on the structural density of the wood, work can thus be effected with an optimized wax admixture of e.g., 2-15%. The barrier layer will not only counteract the exudation of the oil, but also the penetration of water and dirt from the outside.

In connection with the invention, an additional and very wide area of application for the special impregnation agent has been ascertained, namely for effective impregnation of various fibrous products such as textile rain clothing, sails, rope etc. It is well-known to use wax for such purposes, but it is also known that the results are not particularly durable or contact friendly. With the invention, advantage can be taken of the fact that a very effective impregnation can be achieved with only a moderate use of wax, also including against the influence of UV light, without the impregnated articles assuming a character which is precisely that of “wax impregnation”.

In connection with textiles, a wax admixture of approx. 20% will normally be suitable, and this impregnation agent will display a suitable application viscosity by being heated to only approx. 40° C. In general, with the invention it is ensured that benefit can be derived from the special advantages of the said wax, including its high melting point, without a heating having to be effected to a correspondingly wide extent.

Based on the invention, a wax material has been produced solely as a basis for further experiments relating to coating of cast iron. The material, produced by Mobil Oil Denmark A/S, is denoted “Volcoplast 8524”, and it has been used with good results during experiments for more of the disclosed applications. Important material data are as follows:

EVA (ethylvinylacetate) content: 35 weight %

VA (vinylacetate) content: 25 weight % of EVA

Softening point: 100-110° C. ASTM E 28

Penetration, 1/10 mm 250° C.: 2-6 ASTM standard D 1321

Viscosity, mPA.S 130° C.: 280-380 ASTM standard D 3236

Color: L 0.5 ASTM standard D 1500

It will be understood, however, that the invention is in no way limited to the use of just this material. In particular, preferred values for the EVA content are from 20-50 weight %, with the resultant material having a melting point in the range of 102° C. to 125° C. and a penetration of 0.5-6 ASTM standard 1321.

What is claimed is:

1. A construction, molding or coating or impregnating material comprising a wax material with an EVA polymer or copolymer added in amount of 20-50 weight %, said material having a penetration value according to ATSM standard D-1321 of 0.5-6 and a melting point in range of 102-125° C.

2. A material according to claim 1, comprising an EVA content in the range from 25-50 weight % polymer or copolymer.

3. A material according to claim 2, wherein the EVA content is about 25 weight % and the vinylacetate content is 30 weight % thereof.

4. A material according to claim 1, wherein the material is in the form of a plate or block for machining into objects.

5. A material according to claim 1, wherein the material is a corrosion protective coating material for application on surfaces of other materials.

6. A material according to claim 1, wherein the material is a moldable granular material.

7. A material according to claim 6, the material is a time-release coating for one of an artificial fertilizer, washing powder, and road salt.
